(19) United States
(12) Patent Application Publication
(10) Pub. No.: US 2019/0160959 A1
(43) Pub. Date: May 30, 2019

(54) CAR SHARING FEE SETTING APPARATUS AND METHOD

(71) Applicant: TOYOTA JIDOSHA KABUSHIKI KAISHA, Toyota-shi (JP)

(72) Inventors: Aya ONODERA, Nisshin-shi (JP); Akihiko NAKANISHI, Nisshin-shi (JP); Takumi HAMAJIMA, Osaka-shi (JP); Yusuke TSUTSUI, Anpachi-gun (JP)

(73) Assignee: TOYOTA JIDOSHA KABUSHIKI KAISHA, Toyota-shi (JP)

(21) Appl. No.: 16/196,300

(22) Filed: Nov. 20, 2018

(30) Foreign Application Priority Data
Nov. 24, 2017 (JP) 2017-226102

(51) Int. Cl. B60L 11/18; G06Q 30/02; G06Q 50/06

(52) U.S. Cl. CPC B60L 11/1848; B60Y 2200/91; G06Q 50/06; G06Q 30/0283

(57) ABSTRACT

Upon receiving a scheduled departure time of a vehicle, the fee setting apparatus determines a time slot containing the utilization start time of the vehicle. The fee setting apparatus sets a power unit price for the current utilization of the vehicle based on a power unit price list and a time slot containing the utilization start time of the vehicle. In the power unit price list, the power unit price is registered in association with the unit price of commercial power which fluctuates in different time slots The fee setting apparatus calculates a consumed power amount due to the current utilization of the vehicle based on the SOC at the utilization start time of the vehicle and the SOC at the utilization end time. The fee setting apparatus sets a utilization fee based on the power unit price and the consumed power amount.

This non-provisional application is based on Japanese Patent Application 2017-226102 filed on Nov. 24, 2017 with the Japan Patent Office, the entire contents of which are hereby incorporated by reference.

### BACKGROUND

### Field

The present disclosure relates to the setting of a car sharing fee for an electric vehicle traveling by using electric power stored in a power storage device.

### Description of the Background Art

Car sharing which allows a plurality of users to share one vehicle has become increasingly popular. Car sharing means that a user who does not own a vehicle may register as a member of a car sharing company, and thereby may appropriately utilize a vehicle owned by the car sharing company. In order to promote the car sharing, various car sharing fee schemes have been proposed.

For example, Japanese Patent Laying-Open No. 2012-164210 discloses a fee setting system which offers a discount on the car sharing fee based on driving history information of a vehicle provided for the car sharing. The fee setting system disclosed in Japanese Patent Laying-Open No. 2012-164210 sets the discount on the car sharing fee based on, for example, an acceleration average value or a deceleration average value which are included in the driving history information during the utilization of the vehicle.

### SUMMARY

In recent years, along with the spread of electric vehicles, the electric vehicles are widely used in car sharing. Compared with the sharing of gasoline cars and diesel cars, the sharing of electric vehicles (hereinafter also referred to as “EV car sharing”) is advantageous from the viewpoints of measures against environmental problems such as reducing the amount of CO₂ emissions and alleviation of traffic congestion by decreasing the number of vehicles on road. Therefore, it is expected to further spread the EV car sharing.

It is considered that the EV car sharing may be promoted by adopting a fee setting system for EV car sharing which leads to the spread of EV car sharing.

The fee setting system of Japanese Patent Laying-Open No. 2012-164210 is directed to the sharing of general cars including for example gasoline cars and diesel cars, and thereby is not directed to the promotion of EV car sharing.

The present disclosure has been made to solve the aforementioned problems, and an object thereof is to promote the sharing of electric vehicles by using a fee setting system adapted to the sharing of electric vehicles.

A car sharing fee setting apparatus according to the present disclosure sets a utilization fee for sharing an electric vehicle equipped with a power storage device. The fee setting apparatus includes: a storage device configured to store (i) time information on a charging time of the power storage device, (ii) a consumed power amount due to the utilization of the electric vehicle and (iii) a power unit price for each time slot; and a fee setting device configured to set the utilization fee. The power unit price is defined in association with a unit price of commercial power which fluctuates in different time slots. The power unit price is set in accordance with a time determined from the time information. The fee setting device sets the utilization fee based on the consumed power amount and the power unit price.

A car sharing fee setting method according to another aspect of the present disclosure is a method for setting a utilization fee for sharing an electric vehicle equipped with a power storage device. The fee setting method includes steps of: storing (i) time information on a charging time of the power storage device, (ii) a consumed power amount due to the utilization of the electric vehicle and (iii) a power unit price for each time slot; and setting the utilization fee. The power unit price is defined in association with a unit price of commercial power which fluctuates in different time slots. The power unit price is set in accordance with a time determined from the time information. The utilization fee is set based on the consumed power amount and the power unit price.

According to the configuration mentioned above, the fee setting apparatus stores the power unit price for each time slot, the power unit price being defined in association with the unit price of commercial power which fluctuates in different time slots. The power unit price for EV car sharing is set based on the time information about the charging time of the electric storage device mounted on the electric vehicle (hereinafter simply referred to as “vehicle” where appropriate) used in EV car sharing. Thus, the fee setting system adapted to EV car sharing offers the user a financial merit by setting the utilization fee in association with the charging time of the vehicle and the unit price of commercial power which fluctuates in different time slots, which makes it possible to promote the EV car sharing.

The time information includes a utilization start time at which the utilization of the electric vehicle is started.

According to the configuration mentioned above, the utilization start time is used as the time information. For example, the time at which the vehicle is charged may be determined based on the utilization start time of the vehicle by assuming that the vehicle is charged in a time slot before the utilization start time of the vehicle. If the vehicle utilized by the user is charged in a time slot during which the unit price of commercial power is lower, the utilization fee for EV car sharing is set to a lower price compared with the case where the vehicle utilized by the user is charged in a time slot during which the unit price of commercial power is higher.

Thus, the fee setting system adapted to EV car sharing offers the user a financial merit by setting the power unit price based on the utilization start time of the vehicle in association with the unit price of commercial power which fluctuates in different time slots, which makes it possible to promote the EV car sharing.

The time information includes a utilization end time at which the utilization of the electric vehicle is ended.

According to the configuration mentioned above, the utilization end time is used as the time information. For example, the time at which the vehicle is charged may be determined based on the utilization end time of the vehicle by assuming that the vehicle will be charged at a time after the utilization end time of the vehicle. If the vehicle returned by the user may be charged in a time slot during which the unit price of commercial power is lower, the utilization fee for EV car sharing is set to a lower price compared with the case where the vehicle returned by the user will be charged in a time slot during which the unit price of commercial power is higher.

Thus, the fee setting system adapted to EV car sharing offers the user a financial merit by setting the power unit price based on the utilization end time of the vehicle in association with the unit price of commercial power which fluctuates in different time slots, which makes it possible to promote the EV car sharing.

The time information includes a utilization start time at which the utilization of the electric vehicle is started and a utilization end time at which the utilization of the electric vehicle is ended.

According to the configuration mentioned above, the power unit price is set based on the information on the utilization start time and the information on the utilization end time of the vehicle. Thereby, for example, the utilization fee for EV car sharing is set to a lower price if the user utilizes the vehicle charged in a time slot during which the unit price of commercial power is lower and the user returns the vehicle such that the vehicle may be charged in a time slot during which the unit price of commercial power is lower.

Thus, the fee setting system adapted to EV car sharing offers the user a financial merit by setting the power unit price in association with the unit price of commercial power which fluctuates in different time slots, which makes it possible to promote EV car sharing.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating the overall configuration of a fee setting system according to a first embodiment;

FIG. 2 is a diagram illustrating an example of a detailed structure for charging an electric vehicle according to the first embodiment;

FIG. 3 is a functional block diagram illustrating the configuration of a controller of the fee setting apparatus according to the first embodiment;

FIG. 4 is a diagram illustrating an example of a power unit price list stored in the fee setting apparatus according to the first embodiment;

FIG. 5 is a diagram illustrating an example of a user list stored in the fee setting apparatus according to the first embodiment;

FIG. 6 is a flowchart illustrating a process executed by the fee setting apparatus according to the first embodiment;

FIG. 7 is a diagram illustrating an example of a power unit price list stored in the fee setting apparatus according to a second embodiment;

FIG. 8 is a diagram illustrating an example of a user list stored in the fee setting apparatus according to the second embodiment;

FIG. 9 is a flowchart illustrating a process executed by the fee setting apparatus according to the second embodiment;

FIG. 10 is a diagram illustrating an example of a power unit price list stored in the fee setting apparatus according to a third embodiment;

FIG. 11 is a diagram illustrating an example of a user list stored in the fee setting apparatus according to the third embodiment; and

FIG. 12 is a flowchart illustrating a process executed by the fee setting apparatus according to the third embodiment.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### First Embodiment

(Configuration of Fee Setting System)

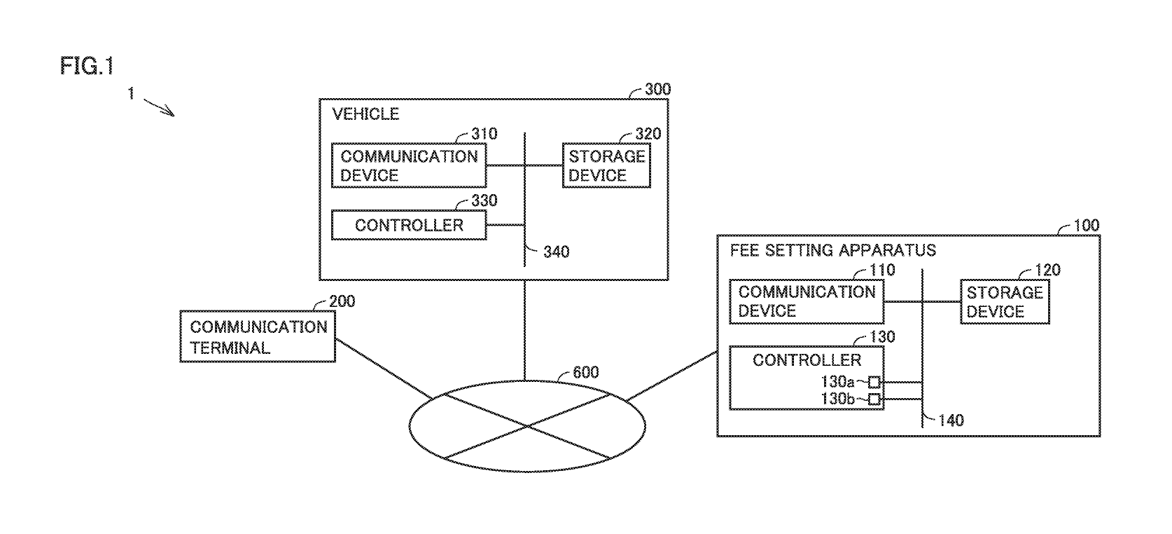

FIG. 1 is a diagram schematically illustrating the overall configuration of a fee setting system 1 according to a first embodiment. As illustrated in FIG. 1, the fee setting system 1 according to the first embodiment includes a fee setting apparatus 100, a communication terminal 200, and a vehicle 300 which is an electric vehicle.

The communication terminal 200 is configured to be used by a user utilizing the fee setting system 1 according to the first embodiment, and may be, for example, a smart phone, a personal computer or the like. The user may use the communication terminal 200 to make membership registration for the EV car sharing provided with the fee setting system 1 and/or make a vehicle reservation.

The fee setting apparatus 100 includes a communication device 110, a storage device 120 and a controller 130, which are connected by a communication bus 140 so as to communicate with each other.

The communication device 110 is configured to communicate with a communication device 310 of the vehicle 300 and the communication terminal 200. The communication between the communication device 110 and the communication device 310 or between the communication device 110 and the communication terminal 200 is established via a communication network 600 such as the Internet or a telephone line.

The storage device 120 may be a mass storage device such as a hard disk drive or a solid state drive. The storage device 120 stores information of users who are registered as members for EV car sharing, information of a vehicle 300 used in EV car sharing and the like.

Further, the storage device 120 stores a power unit price list 500 for setting a power unit price for the utilization of EV car sharing. Furthermore, the storage device 120 stores a user list 700 which is registered with a time slot containing the utilization start time of the vehicle 300, the power unit price and the like defined in association with each user. The details of the power unit price list 500 and the user list 700 will be described later.

The controller 130 includes, for example, a CPU (Central Processing Unit) 130a, a memory (including ROM and RAM) 130b, and an input/output port (not shown) for inputting/outputting various signals. The controller 130 is configured to execute a predetermined arithmetic processing based on information stored in the storage device 120 and information received from the communication terminal 200 or the vehicle 300 via the communication device 110. The details of the controller 130 will be described later.

The vehicle 300 includes a communication device 310, a storage device 320 and a controller 330, which are connected by a communication bus 340 so as to communicate with each other.

The communication device 310 is configured to communicate with the communication device 110 of the fee setting apparatus 100. The communication between the communication device 310 and the communication device 110 is established via the communication network 600.

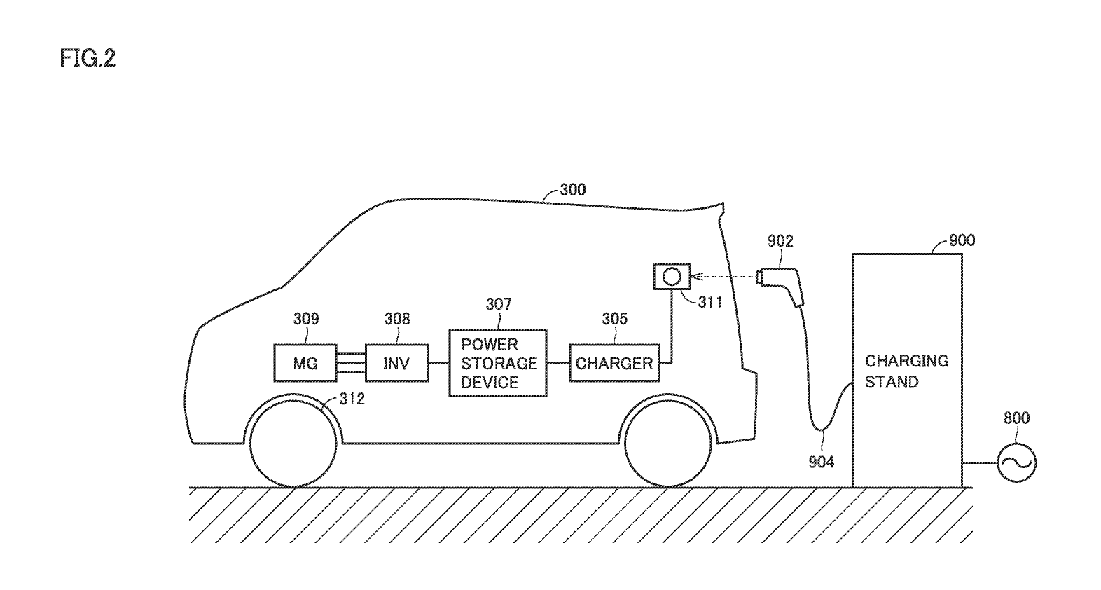

The storage device 320 may be, for example, a storage device such as a nonvolatile storage device, a hard disk drive, a solid state drive or the like. The storage device 320 stores, for example, information on the state of charge (hereinafter also referred to as “SOC”) of a power storage device 307 (FIG. 2), a utilization start time and a utilization end time of the vehicle 300.

The controller 330 includes, for example, a CPU, a memory (including ROM and RAM), and an input/output port (not shown) for inputting/outputting various signals. The controller 330 is configured to execute a predetermined arithmetic processing based on information stored in the storage device 320.

Further, the controller 330 monitors the state of the power storage device mounted on the vehicle 300. For example, the controller 330 detects the voltage, current, and temperature of the power storage device, and calculates the SOC of the power storage device based on the detected values. Any well-known technique may be used to calculate the SOC, and the detailed description thereof will not be given.

When the vehicle 300 is shifted from a READY-OFF state to a READY-ON state, the controller 330 sends to the fee setting apparatus 100 via the communication device 310 vehicle information for identifying the vehicle 300 as well as utilization start information indicating that the utilization of the vehicle 300 is started. When the vehicle 300 is shifted from the READY-ON state to the READY-OFF state, the controller 330 sends to the fee setting apparatus 100 utilization end information indicating that the utilization of the vehicle 300 is ended. Note that the READY-ON state refers to such a state that the vehicle 300 is ready for traveling, and the READY-OFF state refers to such a state that the vehicle 300 is not ready for traveling.

In the EV car sharing where the insertion of a card key to be used in the EV car sharing into the vehicle 300 is detected as the utilization start information of the vehicle and the removal of the card key from the vehicle 300 is detected as the utilization end information of the vehicle, the utilization start information may be sent to the fee setting apparatus 100 by the insertion of the card key into the vehicle 300 and the utilization end information may be sent to the fee setting apparatus 100 by the removal of the card key from the vehicle 300. When the card key is inserted into the vehicle 300, the controller 330 sends the utilization start information and the vehicle information to the fee setting apparatus 100 via the communication device 310. When the card key is removed from the vehicle 300, the controller 330 sends the utilization end information to the fee setting apparatus 100 via the communication device 310.

The controller 330 stores the calculated SOC information in the storage device 320. When the vehicle 300 is in the READY-ON state and is being charged, the controller 330 periodically sends the calculated SOC information to the fee setting apparatus 100. In addition, the controller 330 may send the SOC information of the vehicle 300 to the fee setting apparatus 100 via the communication device 310 in response to a request from the fee setting apparatus 100. Moreover, the controller 330 may send the SOC information of the vehicle 300 to the fee setting apparatus 100 via the communication device 310 when the vehicle 300 is shifted from the READY-ON state to the READY-OFF state.

FIG. 2 is a diagram illustrating an example of a detailed structure for charging an electric vehicle according to the present embodiment. Note that in FIG. 2, the communication device 310, the controller 330 and the like illustrated in FIG. 1 are not illustrated.

As illustrated in FIG. 2, the vehicle 300 further includes a charger 305, a power storage device 307, an inverter 308, a motor generator 309, and a inlet 311.

When a charging connector 902 of a charging stand 900 is plugged in the inlet 311, the charger 305 charges the power storage device 307 by using the electric power supplied from an external power source 800.

The power storage device 307 is made of, for example, a secondary battery such as a nickel hydride battery or a lithium ion battery. The power storage device 307 may be any power storage device capable of storing power. For example, the power storage device 307 may be a capacitor having a large capacity.

The inverter 308 is a power conversion device for converting power between AC power and DC power. For example, the inverter 308 converts DC power from the power storage device 307 into AC power and supplies it to the motor generator 309. On the other hand, the inverter 308 converts AC power (regenerative power) from the motor generator 309 into DC power and supplies it to the power storage device 307 so as to charge the power storage device 307.

The motor generator 309 uses power supplied from the inverter 308 to generate a rotational force, and provide it to driving wheels 312. The driving wheels 312 are rotated by the rotational force provided from the motor generator 309 to move the vehicle 300.

The inlet 311 is provided on an exterior portion of the vehicle 300 together with a cover (not shown) such as a lid. The inlet 311 is shaped in such a manner that allows the charging connector 902 to be plugged therein. Both the inlet 311 and the charging connector 902 have contacts built therein, and when the charging connector 902 is plugged in the inlet 311, the contacts of the charging connector 902 come into contact with the contacts of the inlet 311, and thereby, the inlet 311 and the charging connector 902 are electrically connected.

The charging station 900 is installed outside the vehicle 300 and is connected to the charging connector 902 via a charging cable 904. The charging station 900 is electrically connected to the power source 800. When the charging connector 902 is plugged in the inlet 311, the power is supplied from the power source 800 through the intermediary of the charging station 900, the charging cable 904 and the charging connector 902 to the vehicle 300.

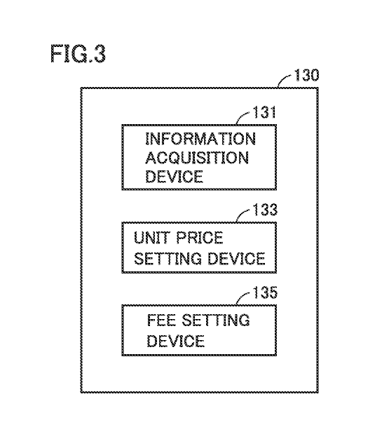

FIG. 3 is a functional block diagram illustrating the configuration of the controller 130 included in the fee setting apparatus 100 according to the first embodiment. The controller 130 includes an information acquisition device 131, a unit price setting device 133, and a fee setting device 135.

The information acquisition device 131 receives, from the communication terminal 200, reservation information on the reservation of the vehicle 300 input by the user. The reservation information includes information on a scheduled departure time at which it is scheduled to start the utilization of the vehicle 300 and information on a scheduled return time at which it is scheduled to end the utilization of the vehicle 300.

Moreover, the information acquisition device 131 receives from the vehicle 300 the utilization start information, the utilization end information, the SOC information at the utilization start time and the SOC information at the utilization end time of the vehicle 300 and the like.

The unit price setting device 133 sets the power unit price in the power unit price list 500 to be described later. The power unit price list 500 is registered with the power unit price for each time slot. The power unit price registered in the power unit price list 500 is set in association with the unit price of commercial power. The unit price of commercial power may be adjusted up or down. In addition, the unit price of commercial power may fluctuate in different seasons. When the unit price of commercial power fluctuates as described above, the unit price setting device 133 re-sets the power unit price and registers it in the power unit price list 500.

The fee setting device 135 sets a utilization fee to be billed for EV car sharing from a user who utilizes the vehicle 300. The setting of the utilization fee will be described in detail later.

(EV Car Sharing)

In recent years, along with the spread of electric vehicles, the electric vehicles are widely used in car sharing. Compared with the sharing of gasoline cars and diesel cars, the sharing of electric vehicles (hereinafter also referred to as “EV car sharing”) is advantageous from the viewpoints of measures against environmental problems such as reducing the amount of CO₂ emissions and alleviation of traffic congestion by decreasing the number of vehicles on road. Therefore, it is expected to further spread the EV car sharing.

It is considered that the EV car sharing may be promoted by adopting a fee setting system for EV car sharing which leads to the spread of EV car sharing, but such a fee setting system is not available.

In the first embodiment, it is assumed that the unit price of commercial power may fluctuate in different time slots between a higher price (first unit price) and a lower price (second unit price). If the user utilizes the vehicle 300 charged in a time slot during which the unit price of commercial power is lower, the power unit price is set lower in accordance with the unit price of commercial power. The time at which the vehicle 300 is charged is determined based on information on the utilization start time of the vehicle 300.

If the user utilizes the vehicle 300 charged in a time slot during which the unit price of commercial power is lower, the utilization fee for EV car sharing is set to a lower price compared with the case where the user utilizes the vehicle 300 charged in a time slot during which the unit price of commercial power is higher.

Thus, the fee setting system adapted to EV car sharing offers the user a financial merit by setting the power unit price in association with the unit price of commercial power which fluctuates in different time slots, which makes it possible to promote the EV car sharing.

(Power Unit Price List 500)

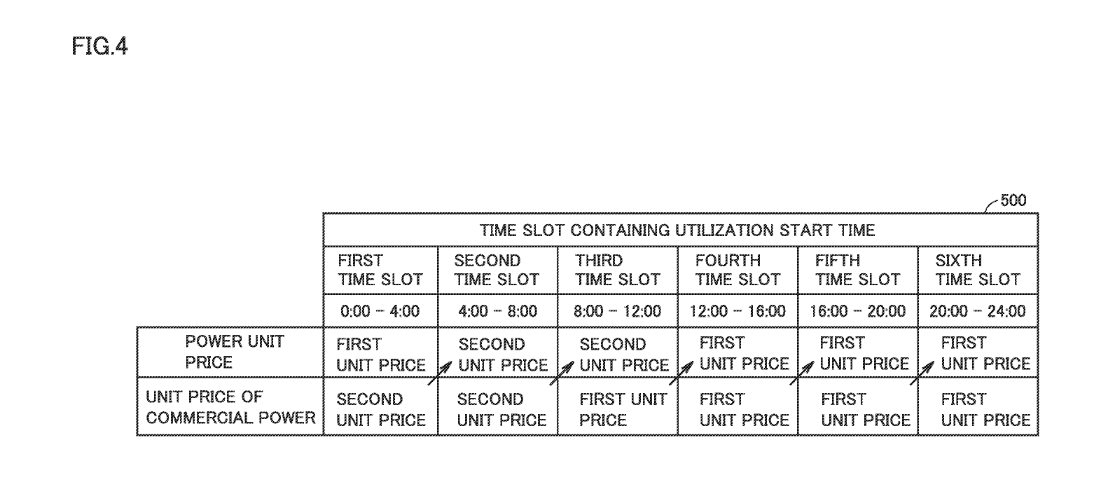

FIG. 4 is a diagram illustrating an example of the power unit price list 500 stored in the fee setting apparatus 100 according to the first embodiment. In the first embodiment, the information on the utilization start time of the vehicle 300 is used to determine the time at which the vehicle 300 is charged. The fee setting apparatus 100 compares a time slot containing therein the utilization start time of the vehicle 300 with the power unit price list 500 to set the power unit price.

In the first embodiment, the time at which the vehicle 300 is charged is determined by assuming the vehicle 300 is charged in a time slot before the time slot containing the utilization start time of the vehicle 300. As to be described below, in order to set the power unit price by comparing the information (time slot) of the utilization start time of the vehicle 300 with the power unit price list 500, the unit price registered in the “power unit price” is not the “unit price of commercial power” for the same time slot, but the “unit price of commercial power” for a previous time slot.

As illustrated in FIG. 4, the power unit price list 500 is registered with the “power unit price” and the “unit price of commercial power” in each time slot.

In the first embodiment, one day (24 hours) is divided into six time slots (first time slot to sixth time slot). The first time slot is from 0:00 to 4:00. The second time slot is from 4:00 to 8:00. The third time slot is from 8:00 to 12:00. The fourth time slot is from 12:00 to 16:00. The fifth time slot is from 16:00 to 20:00. The sixth time slot is from 20:00 to 24:00.

For example, the power unit price set by an electric power company is registered in the “unit price of commercial power”. Every time when the power unit price set by the electric power company fluctuates, the “unit price of commercial power” is updated so as to reflect the fluctuation.

In the first embodiment, the unit price of commercial power is set to a second unit price which is lower than the first unit price in the first time slot and the second time slot, and is set to the first unit price in the third time slot to the sixth time slot.

The “power unit price” is registered in association with the unit price of commercial power. In the first embodiment, the unit price registered in the “power unit price” is not the “unit price of commercial power” for the same time slot, but the “unit price of commercial power” for a previous time slot. Specifically, the power unit price for the second time slot is registered with the unit price of commercial power for the first time slot which is a previous time slot to the second time slot. Since the unit price of commercial power for the first time slot is the second unit price, the second unit price is registered as the power unit price for the second time slot. Note that the power unit price for the first time slot is registered with the unit price of commercial power for the sixth time slot.

As described above, by registering the unit price of commercial power as the power unit price for a previous time slot instead of the power unit price for the same time slot, it is possible to set the power unit price by comparing the information on the utilization start time of the vehicle 300 with the power unit price list 500.

(User List 700)

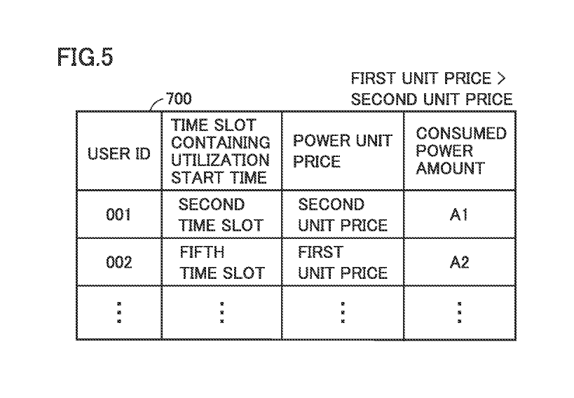

FIG. 5 is a diagram illustrating an example of the user list 700 stored in the fee setting apparatus 100 according to the first embodiment. As illustrated in FIG. 5, the user list 700 is registered with “time slot containing utilization start time”, “power unit price”, and “consumed power amount” in association with each user identified by “user ID”.

After a user has completed the membership registration for EV car sharing, the “user ID” is issued to the user for identifying the user.

The “time slot containing utilization start time” is registered with the time slot containing the time at which the user starts the utilization of the vehicle 300. In the first embodiment, a scheduled departure time input by the user at the time of making a reservation of the vehicle 300 from the communication terminal 200 is used as the utilization start time. It should be noted that a time at which the user actually starts the utilization of the vehicle 300 may be used as the utilization start time. For example, the time at which the fee setting apparatus 100 receives the utilization start information from the vehicle 300 may be used as the utilization start time.

The “power unit price” is set and registered by the fee setting apparatus 100 by comparing the time slot containing the utilization start time with the power unit price list 500.

The “consumed power amount” is registered with the power amount consumed due to the utilization of the vehicle 300. In the first embodiment, the consumed power amount may be calculated from the SOC at the utilization start time of the vehicle 300 and the SOC at the utilization end time of the vehicle 300.

(Process for Setting Utilization Fee)

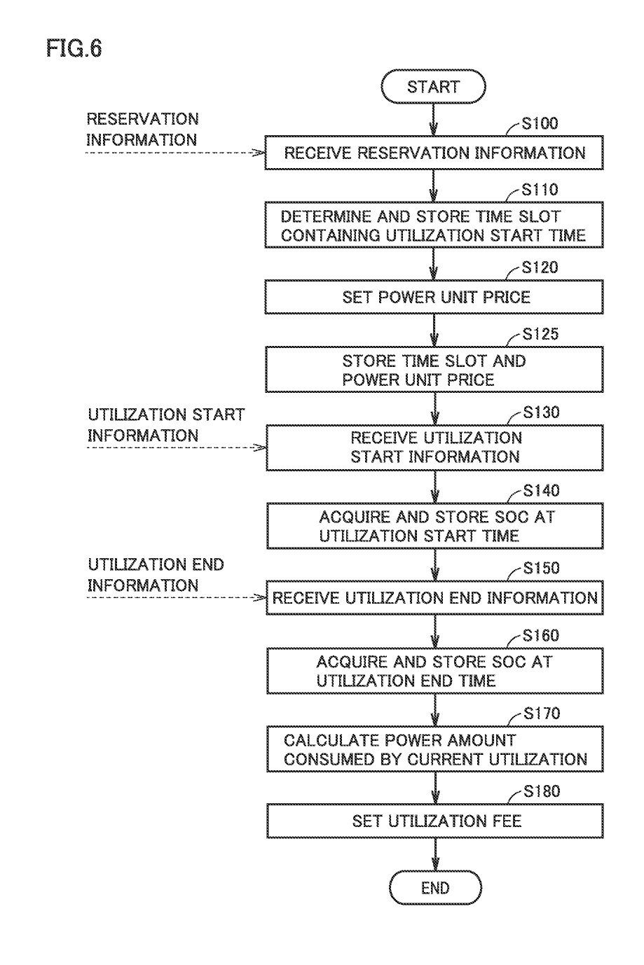

FIG. 6 is a flowchart illustrating a process executed by the fee setting apparatus 100 according to the first embodiment. Each step of the flowchart illustrated in FIG. 6 is executed by software included in the fee setting apparatus 100, but a part of the steps may be executed by hardware (such as an electric circuit) provided in the fee setting apparatus 100.

Upon receiving the reservation information of EV car sharing from the communication terminal 200 of a user via the communication device 110 (step 100, and hereinafter the term of “step” will be abbreviated as “S”), the controller 130 determines the utilization start time based on the information on the scheduled departure time of the vehicle 300 included in the reservation information, and thereby determines the time slot containing the utilization start time (S110).

Then, the controller 130 sets the power unit price by comparing the time slot containing the determined utilization start time with the power unit price list 500 (S120).

The controller 130 registers the time slot containing the utilization start time determined in the above and the power unit price set in the above in the user list 700 (S125).

Upon receiving the utilization start information from the vehicle 300 (S130), the controller 130 acquires the SOC information at the utilization start time of the vehicle 300 and stores it in the storage device 120 (S140).

Upon receiving the utilization end information from the vehicle 300 (S150), the controller 130 acquires the SOC information at the utilization end time of the vehicle 300 (S160). The controller 130 calculates the consumed power amount for the current utilization of the vehicle 300 based on the SOC information at the utilization start time of the vehicle 300 acquired in S140 and the SOC information at the utilization end time of the vehicle 300 acquired in S160 (S170).

The controller 130 reads the power unit price registered in the user list 700 in S125, and sets the current utilization fee for EV car sharing based on the power unit price and the power amount calculated in S170 (S180).

As described above, in the first embodiment, when the unit price of commercial power fluctuates in different time slots between a higher price (first unit price) and a lower price (second unit price), if the user utilizes the vehicle 300 charged in a time slot during which the unit price of commercial power is lower, the power unit price is set lower in accordance with the unit price of commercial power. The time at which the vehicle 300 is charged may be determined based on the information on the utilization start time of the vehicle 300.

If the user utilizes the vehicle 300 charged in a time slot during which the unit price of commercial power is lower, the utilization fee for EV car sharing is set to a lower price compared with the case where the user utilizes the vehicle 300 charged in a time slot during which the unit price of commercial power is higher.

Thus, the fee setting system adapted to EV car sharing offers the user a financial merit by setting the power unit price based on the utilization start time of the vehicle 300 in association with the unit price of commercial power which fluctuates in different time slots, which makes it possible to promote the EV car sharing. The information on the utilization start time corresponds to the “time information” in the present disclosure.

In the first embodiment, one day (24 hours) is divided into six time slots, but it is not limited thereto, it may be divided into less than six time slots or it may be divided into more than six time slots. Moreover, it is not necessary that each time slot is divided in uniform time length. For example, the time slots may be divided in such a manner that the first time slot is from 0:00 to 4:00 and the second time slot is from 4:00 to 6:00.

In addition, it is not limited to divide a period of time into time slots, and thus, the power unit price may be set at any time.

In the first embodiment, the first unit price and the second unit price, which are the same as the “unit price of commercial power”, are registered in the “power unit price”. The “power unit price” may be registered with a certain margin to the “unit price of commercial power”. For example, the “power unit price” may be registered with a fourth unit price with a certain margin to the first unit price instead of the first unit price, or a fifth unit price with a certain margin to the second unit price instead of the second unit price.

### Second Embodiment

(Configuration of Fee Setting System)

In the first embodiment, it is described that the power unit price is set based on the information on the utilization start time of the vehicle 300. In the second embodiment, the power unit price is set based on the information on the utilization end time of the vehicle 300.

In the first embodiment, at the time of setting the power unit price based on the information on the utilization start time of the vehicle 300, if the user utilizes the vehicle 300 charged in a time slot during which the unit price of commercial power is lower, the power unit price is set lower. In the second embodiment, if the user returns the vehicle 300 such that the vehicle 300 may be charged in a time slot during which the unit price of commercial power is lower, the unit price is set lower based on the information on the utilization end time of the vehicle 300.

Since the configuration of the fee setting system according to the second embodiment is the same as that of the fee setting system 1 according to the first embodiment, the description thereof will not be repeated.

(Power Unit Price List 550)

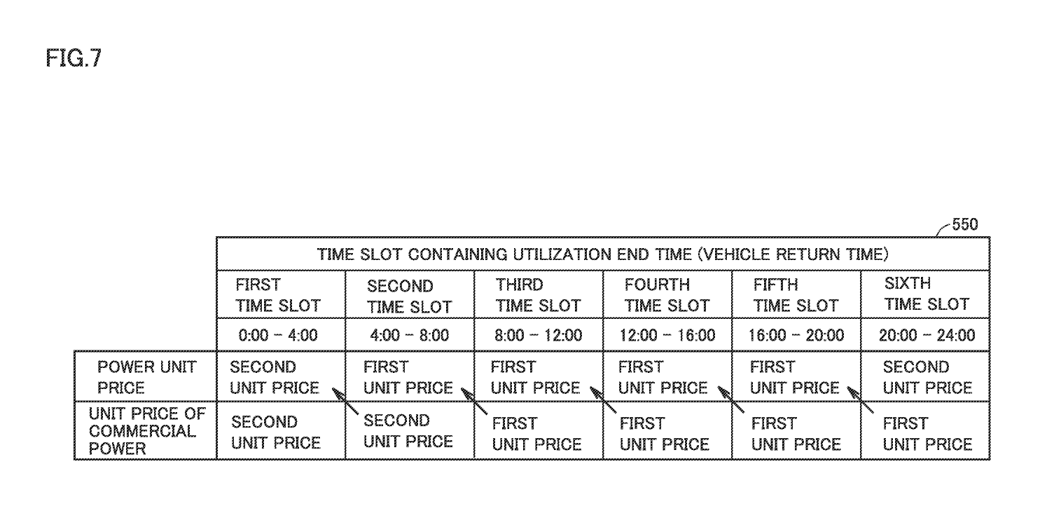

FIG. 7 is a diagram illustrating an example of a power unit price list 550 stored in the fee setting apparatus 100 according to the second embodiment. In the first embodiment, the information on the utilization end time of the vehicle 300 is used to determine the time at which the vehicle 300 is charged. The fee setting apparatus 100 compares a time slot containing therein the utilization end time of the vehicle 300 with the power unit price list 550 to set the power unit price.

In the second embodiment, the time at which the vehicle 300 is charged is determined by assuming that the vehicle 300 will be charged in a time slot next to the time slot containing the utilization end time of the vehicle 300. As to be described below, in order to set the power unit price by comparing the information (time slot) of the utilization end time of the vehicle 300 with the power unit price list 550, the unit price registered in the “power unit price” is not the “unit price of commercial power” for the same time slot, but the “unit price of commercial power” for the next time slot.

As illustrated in FIG. 7, since the power unit price list 550 is the same as the power unit price list 500 according to the first embodiment except for the items registered in the “power unit price”, the description thereof will not be repeated.

In the second embodiment, the unit price registered in the “power unit price” is not the “unit price of commercial power” for the same time slot, but the “unit price of commercial power” for the next time slot. Specifically, the unit price of commercial power for the second time slot which is the next time slot ahead of the first time slot is registered as the power unit price for the first time slot. Since the unit price of commercial power for the second time slot is the second unit price, the second unit price is registered as the power unit price for the first time slot.

As described above, by registering the unit price of commercial power as the power unit price for the next time slot instead of the power unit price for the same time slot, it is possible to set the power unit price by comparing the information on the utilization end time of the vehicle 300 with the power unit price list 550.

(User List 700A)

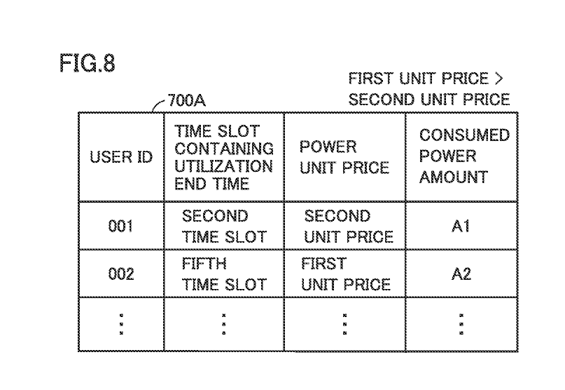

FIG. 8 is a diagram illustrating an example of a user list 700A stored in the fee setting apparatus 100 according to the second embodiment. As illustrated in FIG. 8, the user list 700A is registered with “time slot containing utilization end time”, “power unit price”, and “consumed power amount” in association with each user identified by “user ID”. Since the user list 700A is similar to the user list 700 according to the first embodiment except for the “time slot containing utilization end time” and the “power unit price”, the description thereof will not repeated.

The “time slot containing utilization end time” is registered with the time slot containing the time at which the utilization of the vehicle 300 by the user is ended. In the second embodiment, the time at which the fee setting apparatus 100 receives the utilization end information from the vehicle 300 is used as the utilization end time. It should be noted that a scheduled return time input by the user at the time of making a reservation of the vehicle 300 from the communication terminal 200 may be used as the utilization end time.

The “power unit price” is set and registered by the fee setting apparatus 100 by comparing the time slot containing the utilization end time with the power unit price list 550.

(Process for Setting Utilization Fee)

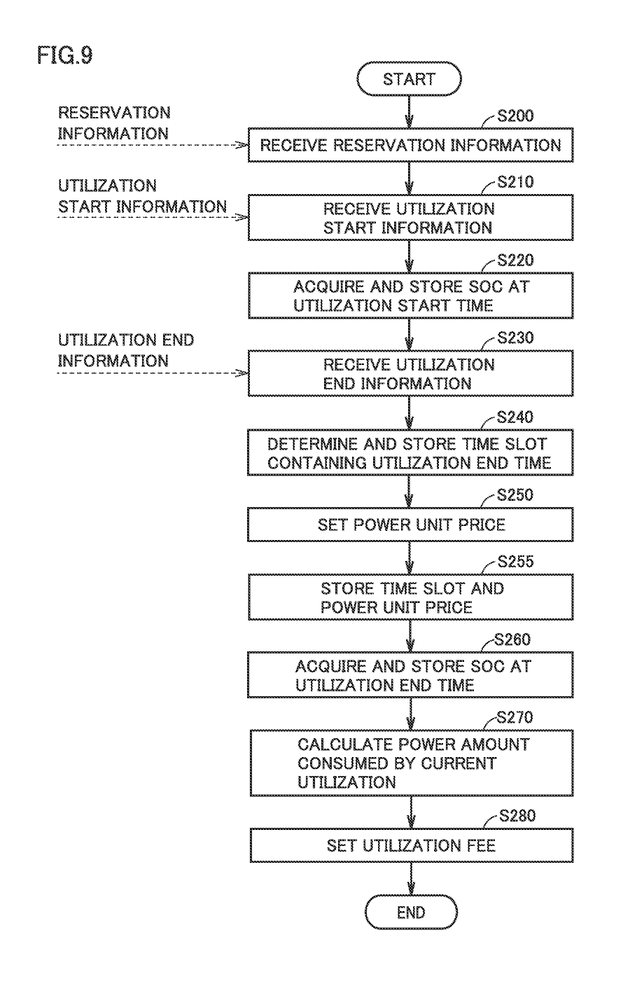

FIG. 9 is a flowchart illustrating a process executed by the fee setting apparatus 100 in the second embodiment. Each step of the flowchart illustrated in FIG. 9 is executed by software included in the fee setting apparatus 100, but a part of the steps may be executed by hardware (such as an electric circuit) provided in the fee setting apparatus 100.

Upon receiving the reservation information of EV car sharing from the communication terminal 200 of a user via the communication device 110 (S200), the controller 130 stores information on a scheduled departure time of the vehicle 300 and information on a scheduled return time included in the reservation information in the storage device 120.

Upon receiving the utilization start information from the vehicle 300 (S210), the controller 130 acquires the SOC information at the utilization start time of the vehicle 300 and stores it in the storage device 120 (S220).

Upon receiving the utilization end information from the vehicle 300 (S230), the controller 130 determines the time at which the utilization end information is acquired, and thereby determines the time slot containing the utilization end time (S240).

Then, the controller 130 sets the power unit price by comparing the time slot containing the determined utilization end time with the power unit price list 550 (S250).

The controller 130 registers the time slot containing the utilization end time determined in the above and the power unit price set in the above in the user list 700A (S255).

The controller 130 acquires the SOC information at the utilization end time of the vehicle 300 (S260). The controller 130 calculates the consumed power amount for the current utilization of the vehicle 300 based on the SOC information at the utilization start time of the vehicle 300 acquired in S220 and the SOC information at the utilization end time of the vehicle 300 acquired in S260 (S270).

The controller 130 reads the power unit price registered in the user list 700A in S255 and sets the current utilization fee for EV car sharing based on the power unit price and the power amount calculated in S270 (S280).

As described above, when the unit price of commercial power fluctuates in different time slots between a higher price and a lower price, if the user returns the vehicle 300 such that the vehicle 300 may be charged in a time slot during which the unit price of commercial power is lower, it is possible to charge the vehicle 300 at a lower price. Thus, the power unit price is set lower in accordance with the unit price of commercial power. The time at which the vehicle 300 is charged may be determined based on the information on the utilization end time of the vehicle 300.

If the user returns the vehicle 300 such that the vehicle 300 may be charged in a time slot during which the unit price of commercial power is lower, the utilization fee for EV car sharing is set to a lower price compared with the case where the user returns the vehicle 300 such that the vehicle 300 will be charged in a time slot during which the unit price of commercial power is higher.

Thus, the fee setting system adapted to EV car sharing offers the user a financial merit by setting the power unit price based on the utilization end time of the vehicle 300 in association with the unit price of commercial power which fluctuates in different time slots, which makes it possible to promote the EV car sharing. The information on the utilization end time corresponds to the “time information” in the present disclosure.

### Third Embodiment

(Configuration of Fee Setting System)

In the first embodiment, it is described that the power unit price is set based on the information on the utilization start time of the vehicle 300. In the second embodiment, the power unit price is set based on the information on the utilization start time and the information on the utilization end time of the vehicle 300. In the third embodiment, the power unit price is set based on both the information on the utilization start time and the information on the utilization end time of the vehicle 300.

In the third embodiment, if the user utilizes the vehicle 300 charged in a time slot during which the unit price of commercial power is lower and the user returns the vehicle 300 such that the vehicle 300 may be charged in a time slot during which the unit price of commercial power is lower, the power unit price is set lower.

Since the configuration of the fee setting system according to the third embodiment is the same as that of the fee setting system 1 according to the first embodiment and the second embodiment, the description thereof will not be repeated.

In the third embodiment, in addition to the power unit price list 500 described in the first embodiment and the power unit price list 550 described in the second embodiment, a power unit price list 570 is stored in the storage device 120.

(Power Unit Price List 570)

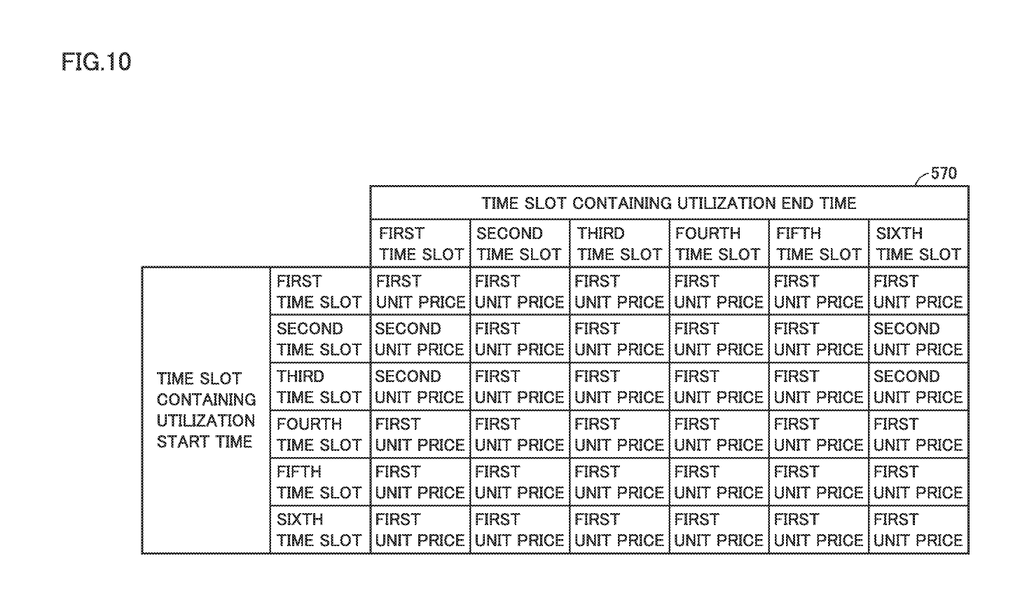

FIG. 10 is a diagram illustrating an example of the power unit price list 570 stored in the fee setting apparatus 100 according to the third embodiment. As illustrated in FIG. 10, the power unit price is set in the power unit price list 570 from a combination of each time slot containing the utilization start time and each time slot containing the utilization end time. Either the first unit price or the second unit price is registered in each block specified by the combination of each time slot containing the utilization start time and each time slot containing the utilization end time. The method for setting the power unit price to be registered in each block will be described below.

The power unit price to be registered in each block is set based on (i) information as to whether the power unit price at each time slot containing the utilization start time is the first unit price (high price) or the second unit price (low price) by referring to the power unit price list 500 and (ii) information as to whether the power unit price at each time slot containing the utilization end time is the first unit price or the second unit price by referring to the power unit price list 550. Specifically, if the power unit price in a time slot containing the utilization start time and the power unit price in a time slot containing the utilization end time are both the second unit price, the power unit price in the block is set to the second unit price. On the other hand, if at least one of the power unit price in the time slot containing the utilization start time and the power unit price in the time slot containing the utilization end time is the first unit price, the power unit price in the block is set to the first unit price.

As an example, if the time slot containing the utilization start time is the first time slot and the time slot containing the utilization end time is the first time slot, the power unit price in the block is set to the first unit price with reference to the power unit price list 570. If the time slot containing the utilization start time is the second time slot and the time slot containing the utilization end time is the first time slot, the power unit price in the block is set to the second unit price with reference to the power unit price list 570.

(User List 700B)

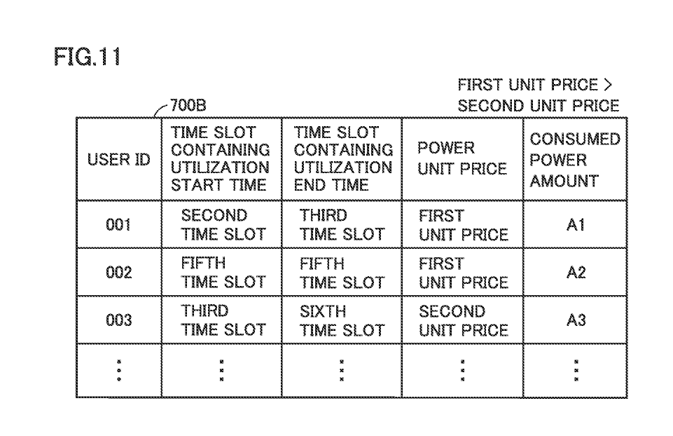

FIG. 11 is a diagram illustrating an example of a user list 700B stored in the fee setting apparatus 100 according to the third embodiment. As illustrated in FIG. 11, the user list 700B is registered with “time slot containing utilization end time”, “power unit price”, and “consumed power amount” in association with each user identified by “user ID”. Since the user list 700B is similar to the user list 700 according to the first embodiment and the user list 700A according to the second embodiment except for the “power unit price”, the description thereof will not repeated.

The “power unit price” is set and registered by the fee setting apparatus 100 by comparing the time slot containing the utilization start time and the time slot containing the utilization end time with the power unit price list 570.

(Process for Setting Utilization Fee)

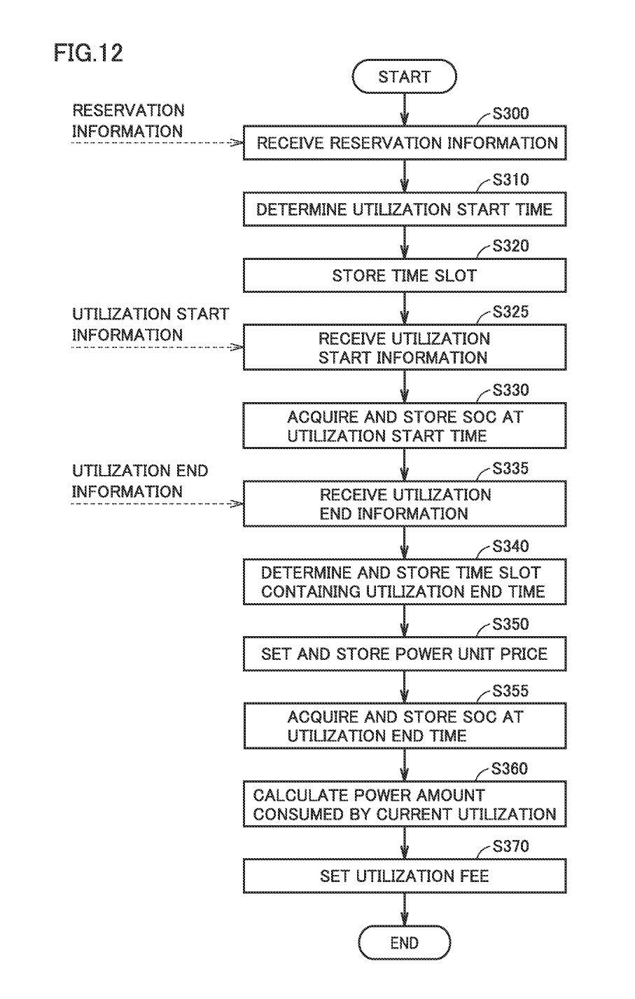

FIG. 12 is a flowchart illustrating a process executed by the fee setting apparatus 100 in the third embodiment. Each step of the flowchart illustrated in FIG. 9 is executed by software included in the fee setting apparatus 100, but a part of the steps may be executed by hardware (such as an electric circuit) provided in the fee setting apparatus 100.

Upon receiving the reservation information of EV car sharing from the communication terminal 200 of a user via the communication device 110 (S300), the controller 130 determines the utilization start time based on the information on the scheduled departure time of the vehicle 300 included in the reservation information, and stores it in the storage device (S310). Then, the controller 130 determines the time slot containing the utilization start time from the determined utilization start time, and registers it in the user list 700B (S320).

Upon receiving the utilization start information from the vehicle 300 (S325), the controller 130 acquires the SOC information at the utilization start time of the vehicle 300, and stores it in the storage device 120 (S330).

Upon receiving the utilization end information from the vehicle 300 (S335), the controller 130 determines the time at which the utilization end information is received. Then, the controller 130 determines the time slot containing the utilization end time from the utilization end time, and registers it in the user list 700B (S340).

The controller 130 sets the power unit price by comparing the time slot containing the utilization start time stored in the user list 700 B as described in 5320 and the time slot containing the utilization end time stored in the user list 700 B as described in S340 with the power unit price list 570. The controller 130 registers the power unit price in the user list 700B (S350).

The controller 130 acquires the SOC information at the utilization end time of the vehicle 300 (S355). The controller 130 calculates the consumed power amount for the current utilization of the vehicle 300 based on the SOC information at the utilization start time of the vehicle 300 acquired in S330 and the SOC information at the utilization end time of the vehicle 300 acquired in S355 (S360).

The controller 130 reads the power unit price registered in the user list 700B in S350, and sets the current utilization fee for EV car sharing based on the power unit price and the power amount calculated in S360 (S370).

As described above, in the third embodiment, the power unit price is set based on both the information on the utilization start time and the information on the utilization end time of the vehicle 300. Thereby, if the user utilizes the vehicle 300 charged in a time slot during which the unit price of commercial power is lower and the user returns the vehicle 300 such that the vehicle 300 may be charged in a time slot during which the unit price of commercial power is lower, the utilization fee for EV car sharing is set to a lower price.

Thus, the fee setting system adapted to EV car sharing offers the user a financial merit by setting the power unit price in association with the unit price of commercial power which fluctuates in different time slots, which makes it possible to promote the EV car sharing.

In the third embodiment, when the power unit price in a time slot containing the utilization start time and the power unit price in a time slot containing the utilization end time are both the second unit price, the power unit price of the EV car sharing is set to the second unit price, but it is not limited thereto, various patterns of setting the power unit price may be considered. For example, when the power unit price in either the time slot containing the utilization start time or the time slot containing the utilization end time is the second unit price, the power unit price of the EV car sharing may be set to a third price which is lower than the first unit price and higher than the second unit price (the first unit price>the third unit price>the second unit price).

The embodiments disclosed herein are illustrative and non-restrictive in any respect. The technical scope indicated by the claims is intended to include any modifications within the scope and meaning equivalent to the terms of the claims.

What is claimed is:

1. A fee setting apparatus configured to set a utilization fee for sharing an electric vehicle equipped with a power storage device, the fee setting apparatus comprising:
a storage device configured to store time information on a charging time of the power storage device, a consumed power amount due to the utilization of the electric vehicle and a power unit price for each time slot, the power unit price being defined in association with a unit price of commercial power which fluctuates in different time slots; and
a fee setting device configured to set the utilization fee,
the power unit price being set in accordance with a time determined from the time information,
the fee setting device being configured to set the utilization fee based on the consumed power amount and the power unit price.

2. The fee setting apparatus according to claim 1, wherein
the time information includes a utilization start time at which the utilization of the electric vehicle is started.

3. The fee setting apparatus according to claim 1, wherein
the time information includes a utilization end time at which the utilization of the electric vehicle is ended.

4. The fee setting apparatus according to claim 1, wherein
the time information includes a utilization start time at which the utilization of the electric vehicle is started and a utilization end time at which the utilization of the electric vehicle is ended.

5. A fee setting method for setting a utilization fee for sharing an electric vehicle equipped with a power storage device, the method comprising:
storing time information on a charging time of the power storage device, a consumed power amount due to the utilization of the electric vehicle and a power unit price for each time slot, the power unit price being defined in association with a unit price of commercial power which fluctuates in different time slots; and
setting the utilization fee,
the power unit price being set in accordance with a time determined from the time information,
the utilization fee being set based on the consumed power amount and the power unit price.
